(19) United States
(12) Patent Application Publication
(10) Pub. No.: US 2026/0162272 A1
(43) Pub. Date: Jun. 11, 2026

(54) SYSTEMS AND METHODS FOR SELF-SUPERVISED TRAINING OF A BIRD’S EYE VIEW SEMANTIC MAPPING MODEL

(71) Applicant: Verizon Patent and Licensing Inc., Basking Ridge, NJ (US)

(72) Inventors: Henrique Pineiro MONTEAGUDO, Florence (IT); Aurel PJETRI, Firenze (IT); Leonardo TACCARI, Florence (IT); Francesco SAMBO, Florence (IT); Samuele SALTI, Prato (IT)

(73) Assignees: Verizon Patent and Licensing Inc., Basking Ridge, NJ (US); Alma Mater-Studiorum - Università di Bologna, Bologna (IT)

(21) Appl. No.: 18/969,766

(22) Filed: Dec. 5, 2024

(51) Int. Cl. G06T 7/12; G06T 7/70; G06T 7/80; G06T 15/20; G06V 20/70

(52) U.S. Cl. CPC G06T 7/12; G06T 7/70; G06T 7/80; G06T 15/20; G06V 20/70; G06T 2207/20081

(57) ABSTRACT

A device may receive video data that includes video frames depicting monocular frontal views, and may select a reference video frame and a target video frame from the video data. The device may process the reference video frame, with a bird's eye view (BEV) model, to generate a rendered semantic segmentation and a BEV prediction, and may sample class probability values from the BEV prediction. The device may process the target video frame, with a geometry model, to generate densities, and may generate a target semantic segmentation based on the class probability values and the densities. The device may calculate a cross-entropy loss based on the rendered semantic segmentation and the target semantic segmentation, and may train the BEV model, with the cross-entropy loss, in order to generate a trained BEV model.

### BACKGROUND

Assisted and autonomous driving requires sophisticated environmental representations to improve vehicular safety and navigation. A bird's eye view (BEV) is particularly beneficial, since the BEV offers a top-down, orthographic projection that is highly conducive to depicting the surroundings of a vehicle.

### BRIEF DESCRIPTION OF THE DRAWINGS

FIGS. 1A-1H are diagrams of an example associated with self-supervised training of a BEV semantic mapping model.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for self-supervised training of a BEV semantic mapping model.

### DETAILED DESCRIPTION OF EXAMPLE EMBODIMENTS

The following detailed description of example implementations refers to the accompanying drawings. The same reference numbers in different drawings may identify the same or similar elements.

A correct BEV representation may maintain object proportions regardless of viewpoint changes, may ensure consistent scale, and may accurately measure distances on flat terrain. The BEV representation may provide substantial information about a driving environment in a more compressed and efficient format as compared to explicit three-dimensional representations. Creating BEV images using multiple cameras is generally not a complex task. However, creating an accurate and reliable BEV representation from monocular camera images, e.g., what might be available in cost sensitive use cases, poses significant challenges. These challenges stem from an inherent loss of depth information during image capture and a complexity associated with manual annotation in creating ground truth datasets needed for fully supervised training of BEV models that generate BEV representations. Fully supervised settings generally require extensive datasets with paired images and corresponding ground truth BEV labels, which involve laborious and costly processes using expensive sensors, as well as considerable post-processing and manual labeling. Furthermore, current techniques for transforming perspective image features into a BEV representation rely on the availability of ground truth annotations for effective supervision.

Thus, current techniques for training BEV models that generate accurate BEV representations consume computing resources (e.g., processing resources, memory resources, communication resources, and/or the like), networking resources, and/or other resources associated with requiring extensive ground truth labels and datasets for training data of the BEV models, utilizing expensive sensors to verify outputs of the BEV models, utilizing extensive post-processing of the outputs generated while training BEV models, and/or the like.

Some implementations described herein provide a video system that provides self-supervised training of a BEV semantic mapping model. For example, the video system may receive video data that includes video frames depicting monocular frontal views of a vehicle, and may select a reference video frame and a target video frame from the video data. The video system may process the reference video frame, with a BEV model, to generate a rendered semantic segmentation and a BEV prediction, and may sample class probability values from the BEV prediction. The video system may process the target video frame, with a geometry model, to generate densities, and may generate a target semantic segmentation based on the class probability values and the densities. The video system may calculate a cross-entropy loss based on the rendered semantic segmentation and the target semantic segmentation, and may train the BEV model, with the cross-entropy loss, in order to generate a trained BEV model.

In this way, the video system provides self-supervised training of a BEV semantic mapping model. For example, the video system may utilize a self-supervised training method that derives accurate BEV semantic segmentation predictions from video data without the need for expensive sensors or ground truth labels. By processing video frames with a BEV model and a geometry model, the video system may compute a rendered semantic segmentation that is compared against a generated target segmentation. This comparison yields a learnable loss metric that continually refines model accuracy. The video system may incorporate a pretrained neural field and volumetric rendering techniques to enhance the capture and projection of three-dimensional environmental features into a two-dimensional image, which provides for accurate BEV semantic segmentation predictions. Thus, the video system may conserve computing resources, networking resources, and/or other resources that would have otherwise been consumed by requiring extensive ground truth labels and datasets for training data of the BEV models, utilizing expensive sensors to verify outputs of the BEV models, utilizing extensive post-processing of the outputs generated while training BEV models, and/or the like.

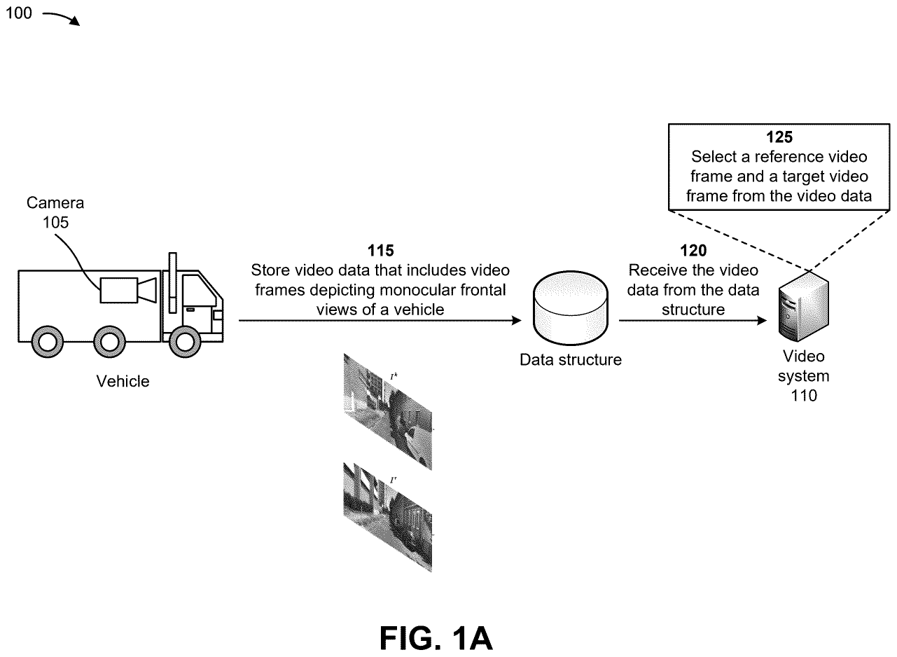

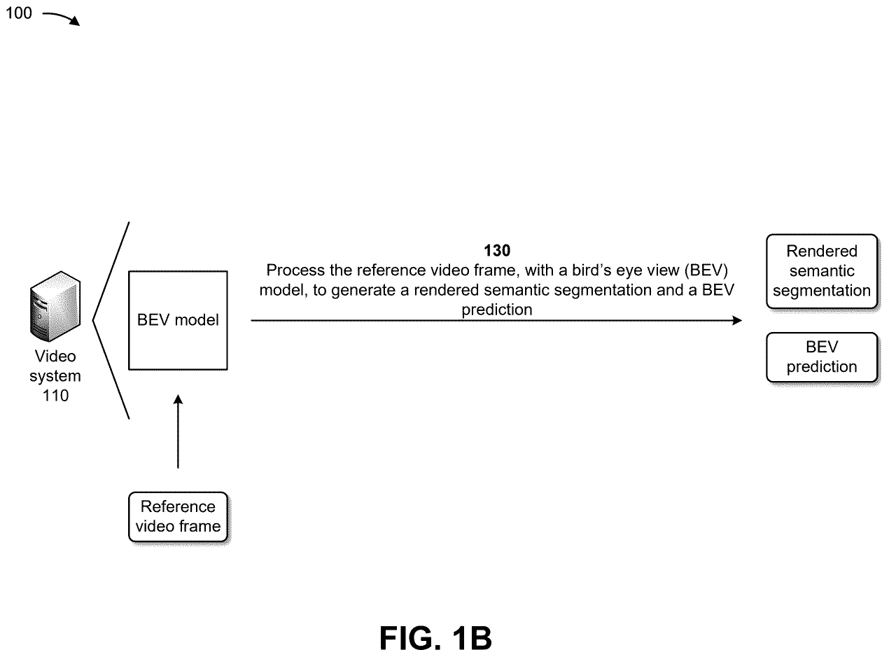

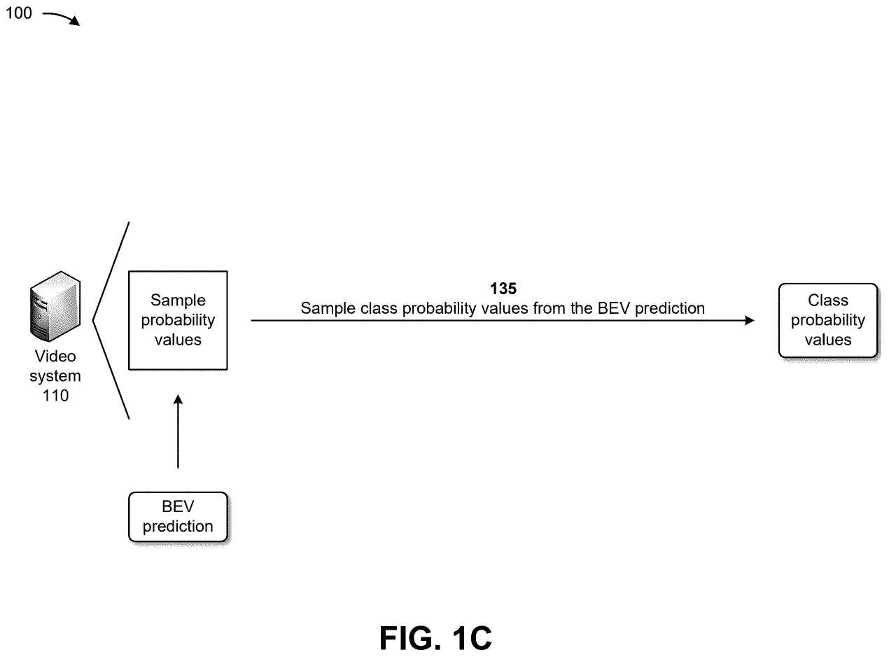

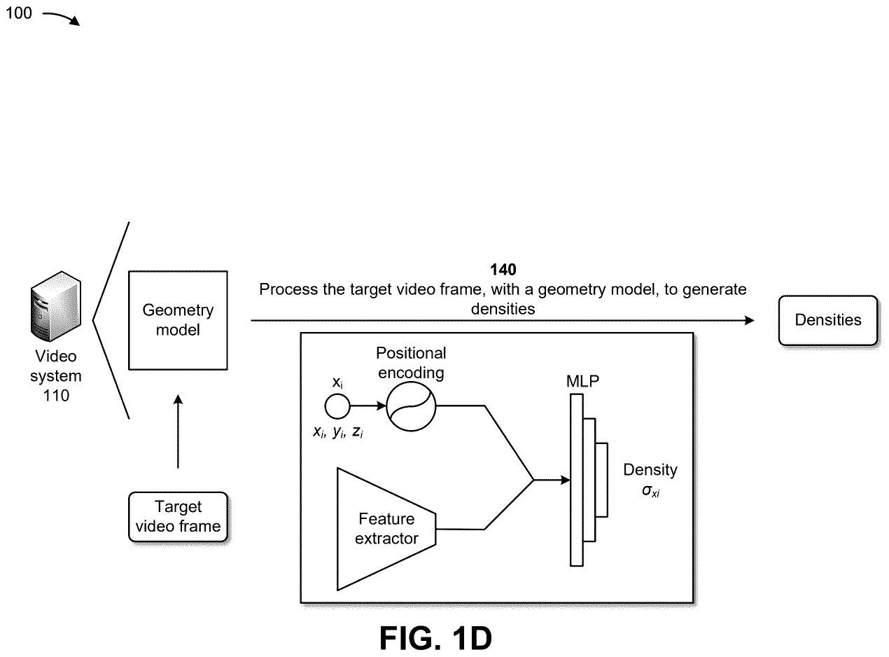

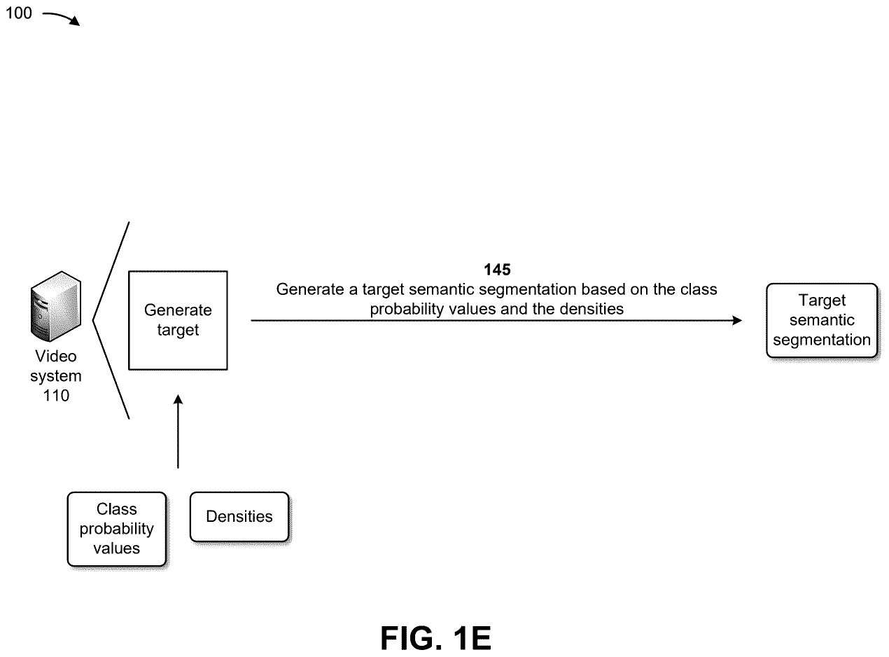

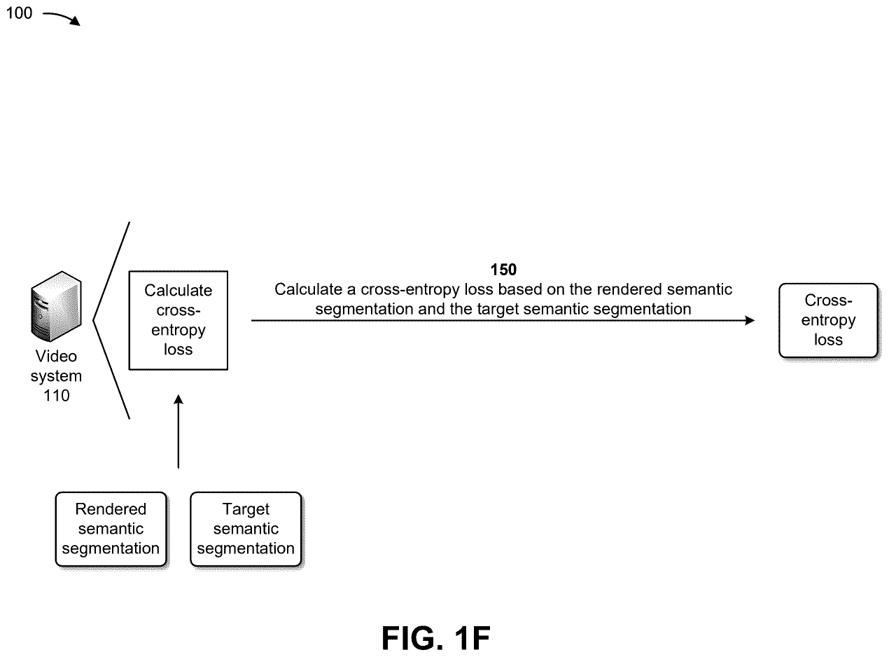

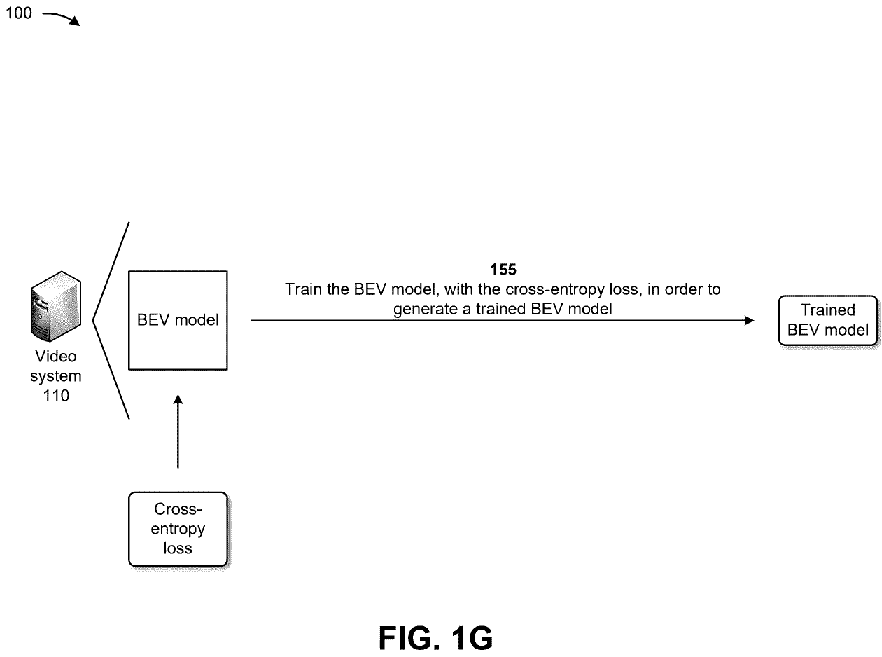

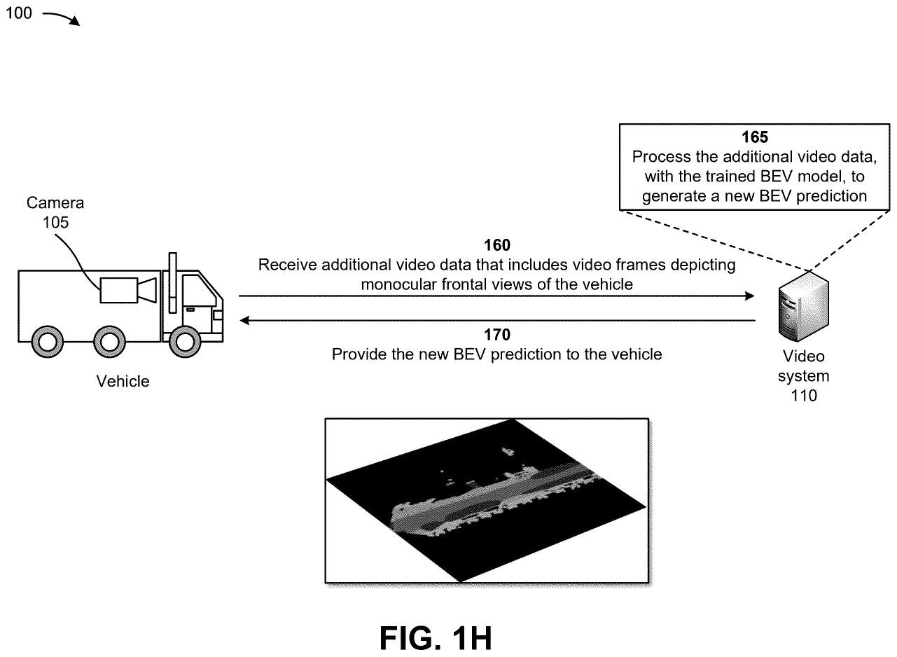

FIGS. 1A-1H are diagrams of an example 100 associated with self-supervised training of a BEV semantic mapping model. As shown in FIGS. 1A-1H, the example 100 includes a camera 105 and a data structure associated with a vehicle and a video system 110. The camera 105 may capture video of objects (e.g., packages, cargo, pedestrians, traffic signs, traffic signals, road markers, a driver, animals, and/or the like) associated with the vehicle. The camera 105 may include a dashcam of the vehicle, a forward-facing camera of the vehicle, a side camera of the vehicle, a rear camera of the vehicle, and/or the like. The data structure may include a database, a table, a list, and/or the like that stores training data. The video system 110 may include a system that provides self-supervised training of a BEV semantic mapping model. Further details of the camera 105, the data structure, the vehicle, and the video system 110 are provided elsewhere herein. Although implementations described herein depict a single vehicle, in some implementations, the video system 110 may be associated with multiple vehicles. Furthermore, although the camera 105 is depicted as being associated with the vehicle, in some implementations, the camera 105 may not be associated with the vehicle.

As shown by FIG. 1A, and by reference number 115, the camera 105 may store, in the data structure, video data that includes video frames depicting monocular frontal views of a vehicle. For example, the camera 105 associated with the vehicle may continuously capture the video data that includes the video frames depicting monocular frontal views of the vehicle. The vehicle may provide the video data to the data structure (e.g., a table, a list, a database, and/or the like) and the data structure may store the video data. In some implementations, the camera 105 may periodically store the video data in the data structure, may continuously store the video data in the data structure, may store the video data in the data structure based on a request, and/or the like. In some implementations, the data structure may store the video data received from multiple dashcams installed in various positions within the vehicle to provide multiple perspectives of the vehicle.

As further shown in FIG. 1A, and by reference number 120, the video system 110 may receive the video data from the data structure. For example, the data structure may store the video data that includes the video frames depicting monocular frontal views of the vehicle, which is captured by the camera 105 associated with the vehicle. In some implementations, the video system 110 may continuously receive the video data from the data structure, may periodically receive the video data from the data structure, may receive the video data from the data structure based on requesting the video data, and/or the like. The video system 110 may retrieve the video data from the data structure for subsequent processing. In some implementations, the video system 110 may access video data directly from the camera 105 or the vehicle instead of retrieving the video data from the data structure. This may reduce latency by eliminating the need for intermediate storage. Additionally, or alternatively, the video system 110 may receive the video data from a network server storing the video data recorded by the vehicle's camera 105. Additionally, or alternatively, the video system 110 may receive real-time streamed video data from the camera 105.

As further shown in FIG. 1A, and by reference number 125, the video system 110 may select a reference video frame and a target video frame from the video data. For example, the video system 110 may analyze the video data to choose specific frames that represent different points in time from a same video sequence. The reference video frame may serve as a baseline, while the target video frame may be used to generate comparative data for further model training and validation. In some implementations, the video system 110 may select the reference video frame and the target video frame using a model designed to maximize frame-to-frame visual differences. This may ensure that the frames used for training provide a wide variety of visual data. Additionally, or alternatively, the video system 110 may select the reference video frame and the target video frame based on an event, such as a detected movement or change in the surroundings.

Additionally, or alternatively, the video system 110 may utilize a machine learning model specifically trained to select key frame pairs for training (e.g., the reference video frame and the target video frame). Additionally, or alternatively, the video system 110 may select the reference video frame and the target video frame based on pre-configured time intervals between frames ensuring a fixed temporal gap. Additionally, or alternatively, the video system 110 may incorporate heuristics or rules based on the vehicle's speed and direction to select the reference video frame and the target video frame. Additionally, or alternatively, the video system 110 may employ spatial criteria for selecting the reference video frame and the target video frame, ensuring that frames depict significantly varied viewpoints of the vehicle surroundings. Additionally, or alternatively, the video system 110 may utilize depth information captured along with video data to select the reference video frame and the target video frame.

Additionally, or alternatively, the video system 110 may utilize metadata attached to each frame (e.g., timestamps, global positioning system (GPS) coordinates, and/or the like) to assist in the selection of the reference video frame and the target video frame. Additionally, or alternatively, the video system 110 may dynamically adjust criteria for selecting the reference video frame and the target video frame based on ongoing analysis metrics or model performance feedback. Additionally, or alternatively, the video system 110 may intermittently receive additional data inputs, such as vehicle sensor data, to refine the selection of the reference video frame and the target video frame. Additionally, or alternatively, the video system 110 may interpolate video frames between the reference video frame and the target video frame to enhance model training. Interpolated frames can fill gaps and provide more data points for the model.

As shown in FIG. 1B, and by reference number 130, the video system 110 may process the reference video frame, with a BEV model, to generate a rendered semantic segmentation and a BEV prediction. For example, the video system 110 may provide the reference video frame as an input to the BEV model, and the BEV model may generate the rendered semantic segmentation of the scene from a top-down perspective, as well as a prediction for each class within the BEV model. In some implementations, the rendered semantic segmentation may provide a representation of the scene that categorizes objects within the reference video frame, such as vehicles, pedestrians, and road features, while the BEV prediction may provide probabilistic assessments for each class, enhancing a capability of the video system 110 to understand and navigate the observed environment. For example, the BEV model may process the reference video frame to annotate features such as roads, sidewalks, and obstacles, ensuring that such elements are accurately reflected in the semantic map.

As shown in FIG. 1C, and by reference number 135, the video system 110 may sample class probability values from the BEV prediction. For example, the video system 110 may analyze the BEV prediction generated by the BEV model to extract class probability values corresponding to different object classes present in the reference video frame. In some implementations, the video system 110 may sample the class probability values from the BEV prediction using statistical or machine learning models to ensure that the sampled values represent a wide range of object types and positions within the reference video frame.

The class probability values may indicate a likelihood that various regions within the reference video frame belong to specific predefined object classes, such as vehicles, pedestrians, road elements, and other relevant objects. The sampling process may collect probabilities associated with each pixel or segment within the BEV prediction, resulting in a probabilistic map that indicates the presence and location of different object classes observed by the camera 105. In some implementations, the video system 110 may prioritize sampling from regions with higher uncertainty or regions representing important navigational or safety features.

In some implementations, the video system 110 may extract the class probability values using a predefined model, such as a set of rules or programmed instructions to methodically extract probabilities for each object class from the BEV prediction. Additionally, or alternatively, the video system 110 may employ a neural network model to identify and sample the class probability values. For example, a neural network model may be trained to recognize and intelligently sample the most relevant class probabilities based on patterns observed in the BEV prediction. Additionally, or alternatively, the video system 110 may utilize an optimization model to determine the most relevant class probability value for sampling.

Additionally, or alternatively, the video system 110 may segment the BEV prediction into grids and may select representative class probability values from each grid. Additionally, or alternatively, the video system 110 may utilize a region-based sampling method to select class probability values from areas of interest within the BEV prediction. Additionally, or alternatively, the video system 110 may utilize a statistical sampling technique, such as stratified sampling, to gather the class probability values. Additionally, or alternatively, the video system 110 may utilize a randomized sampling approach to ensure that a diverse set of class probability values is extracted. Additionally, or alternatively, the video system 110 may apply a confidence threshold to select the class probability value with highest likelihood values. Additionally, or alternatively, the video system 110 may implement a sliding window technique to systematically sample the class probability values across the entire BEV prediction.

Additionally, or alternatively, the video system 110 may focus on areas within the BEV prediction closest to the vehicle's current location when selecting the class probability values. Additionally, or alternatively, the video system 110 may utilize a feature detection model to identify the class probability values from notable features within the BEV prediction. Additionally, or alternatively, the video system 110 may utilize entropy-based sampling to prioritize areas with high information content when selecting the class probability values. Additionally, or alternatively, the video system 110 may utilize a multi-scale sampling approach that extracts the class probability values from different resolutions within the BEV prediction. Additionally, or alternatively, the video system 110 may utilize a heuristic-based sampling method focusing on historically critical regions for navigation and safety when selecting the class probability values. Additionally, or alternatively, the video system 110 may combine multiple strategies to optimize selection of the class probability values.

As shown in FIG. 1D, and by reference number 140, the video system 110 may process the target video frame, with a geometry model, to generate densities. For example, the video system 110 may utilize the geometry model to analyze the target video frame and to produce volumetric density values indicating whether there is a substantial object or surface at various points in the frame. These densities may enable the video system 110 to understand a spatial structure of a scene. The video system 110 may input positional coordinates into a feature extractor of the geometry model to compute the densities, which may be utilized for refining semantic segmentation.

In some implementations, the geometry model may include a depth estimation model that generates depth values. These values may be used to understand relative distances of objects from the camera 105, aiding in semantic segmentation. Additionally, or alternatively, the geometry model may include a point cloud processor that analyzes the target video frame, and converts image pixels into a three-dimensional point cloud representation to extract the densities from the target video frame. Additionally, or alternatively, the geometry model may include a neural radiance field (NeRF) that processes the target video frame to render high-fidelity three-dimensional representations (e.g., densities) of the scene from two-dimensional input data. In some implementations, the geometry model may sample multiple points along rays cast through each pixel in the target video frame and may aggregate the computed densities to render a three-dimensional structure of the scene. This volumetric rendering approach may ensure that a generated BEV semantic map captures fine details about object placement and surface continuity.

Additionally, or alternatively, the geometry model may utilize a cross-frame analysis that aggregates information from multiple consecutive video frames to generate density values. Additionally, or alternatively, the video system 110 may include a layered multi-layer perceptron (MLP) within the geometry model to enhance feature extraction and accurately compute the densities. In some implementations, the video system 110 may utilize optical flow techniques to analyze motion between sequential video frames, aiding in the generation of density values and improving the semantic segmentation by accounting for moving objects. Additionally, or alternatively, the video system 110 may include Kalman filters within the geometry model to track moving objects and refine density values dynamically based on predicted object positions. Additionally, or alternatively, the video system 110 may utilize hierarchical volumetric rendering techniques that process sub-regions of the target video frame at different levels of detail to generate more accurate three-dimensional structural data and densities.

As shown in FIG. 1E, and by reference number 145, the video system 110 may generate a target semantic segmentation based on the class probability values and the densities. For example, the video system 110 may combine the class probability values sampled from the BEV prediction and the densities generated by the geometry model to produce a coherent semantic segmentation of the target video frame. The target semantic segmentation may represent a probabilistic map indicating the most likely object classes for different regions within the target video frame, and may be derived from a comparative analysis of the reference video frame and the target video frame. The video system 110 may utilize sampling rays from the reference video frame and positional data to spatially align and contextualize the class probability values with the densities, which may enhance segmentation accuracy through volumetric rendering.

As shown in FIG. 1F, and by reference number 150, the video system 110 may calculate a cross-entropy loss based on the rendered semantic segmentation and the target semantic segmentation. For example, the video system 110 may analyze the differences between the rendered semantic segmentation and the target semantic segmentation to measure a deviation (e.g., the cross-entropy loss) of the predicted BEV from the actual data. The cross-entropy loss may quantify how well the BEV model predicts the semantic segmentation of the vehicle's environment. In some implementations, the video system 110 may utilize a mean squared error (MSE) loss for calculating the cross-entropy loss. This may include measuring squared differences between the predicted and true values to quantify error. For example, the video system 110 may compute the MSE loss between the rendered semantic segmentation and the target semantic segmentation to evaluate prediction accuracy. Additionally, or alternatively, the video system 110 may utilize a softmax cross-entropy loss for calculating the cross-entropy loss. This method utilizes a standard softmax cross-entropy loss function to measure deviation between predicted probabilities and actual class labels for each pixel in the BEV, providing a more granular assessment. Additionally, or alternatively, the video system 110 may utilize a Dice coefficient loss for calculating the cross-entropy loss. The Dice coefficient loss may provide an indication of a degree of overlap between the rendered semantic segmentation and the target semantic segmentation. In some implementations, the video system 110 may calculate the cross-entropy loss using a binary cross-entropy loss (e.g., for binary classification problems), a categorical cross-entropy loss (e.g., used in multi-class classification problems), a sparse categorical cross-entropy loss, a class-weighted cross-entropy loss, and/or the like.

Furthermore, the video system 110 may utilize focal loss for calculating the cross-entropy loss. Focal loss may add a modulating factor to the cross-entropy loss to focus learning on hard misclassified examples. Additionally, or alternatively, the video system 110 may utilize a Jaccard index (e.g., intersection-over-union) for calculating the cross-entropy loss. This method calculates a ratio of an intersection to a union of the rendered semantic segmentation and the target semantic segmentation. Additionally, the video system 110 may utilize regularization terms (e.g., L2 regularization) for calculating the cross-entropy loss. Additionally, or alternatively, the video system 110 may utilize sampling-based loss calculations for calculating the cross-entropy loss. This approach dynamically samples pixels or regions with high prediction variance, focusing the loss computation on these challenging areas. Additionally, or alternatively, the video system 110 may calculate the cross-entropy loss based on scene context or environmental conditions to ensure that a weighting of the loss function adapts to different weather or lighting conditions.

Furthermore, the video system 110 may utilize hybrid loss functions. Instead of a single loss function, the video system 110 may combine multiple loss functions, such as cross-entropy loss and MSE loss, to capture both probabilistic and absolute error implementations of predictions. Additionally, or alternatively, the video system 110 may utilize leverage reinforcement learning for loss assignment. Reinforcement learning may dynamically adjust loss weights based on predicted success of navigation through the vehicle's environment.

As shown in FIG. 1G, and by reference number 155, the video system 110 may train the BEV model, with the cross-entropy loss, in order to generate a trained BEV model. For example, the video system 110 may utilize the cross-entropy loss to refine parameters of the BEV model. The training process may include back-propagating the cross-entropy loss through the BEV model, and adjusting weights to minimize any discrepancies between the rendered semantic segmentation and the target semantic segmentation. Outputs of the refined BEV model may become more accurate with each iteration, leading to the generation of the trained BEV model capable of accurate BEV semantic segmentation. In some implementations, the video system 110 may average the cross-entropy loss across multiple video frames, and may utilize the average to guide a learning process for the BEV model. Additionally, the video system 110 may include mechanisms for dynamically adjusting training parameters based on the cross-entropy loss, which may ensure optimal efficiency and performance of the trained BEV model.

Additionally, or alternatively, the video system 110 may utilize data augmentation techniques, such as random cropping and rotation, on the video frames used in training the BEV model. Various transformations may be applied to training video frames, which may ensure that the BEV model generalizes well across different scenarios. Additionally, or alternatively, the video system 110 may process video frames at multiple scales to extract finer details, which may enhance semantic prediction capabilities of the BEV model. Additionally, or alternatively, the video system 110 may provide temporal consistency between successive frames to enable the BEV model to maintain coherent semantic segmentation across video sequences. Additionally, or alternatively, the video system 110 may apply regularization methods to the weights of the BEV model to prevent overfitting and to achieve smoother loss surfaces.

Additionally, or alternatively, the video system 110 may utilize different sampling strategies for choosing reference video frames and target video frames to stabilize training and ensure diverse feature learning. Additionally, or alternatively, the video system 110 may pretrain the BEV model using available labeled data from other domains before utilizing the cross-entropy loss. Additionally, or alternatively, the video system 110 may utilize a class-weighted cross-entropy loss to rectify class imbalance within the training data. Advanced loss functions, such as focal loss, tailored to handle hard-to-classify instances more effectively, may also be employed.

As shown in FIG. 1H, and by reference number 160, the video system 110 may receive additional video data that includes video frames depicting monocular frontal views of the vehicle. For example, the camera 105 associated with the vehicle may continuously capture the additional video data that includes the video frames depicting monocular frontal views of the vehicle. The camera 105 may provide the additional video data to the video system 110 and the video system 110 may receive the additional video data. In some implementations, the video system 110 may periodically receive the additional video data, may continuously receive the additional video data, may receive the additional video data based on a request, and/or the like.

As further shown in FIG. 1H, and by reference number 165, the video system 110 may process the additional video data, with the trained BEV model, to generate a new BEV prediction. For example, the video system 110 may provide the additional video data as an input to the trained BEV model, and the trained BEV model may generate the new BEV prediction based on the additional video data. In some implementations, the new BEV prediction may provide a representation of a scene that categorizes objects within the additional video data, such as vehicles, pedestrians, and road features, as well as probabilistic assessments for each class, enhancing a capability of the video system 110 to understand and navigate the observed environment. For example, the trained BEV model may process the reference video frame to annotate features such as roads, sidewalks, and obstacles, ensuring that such elements are accurately reflected in the new BEV prediction.

As further shown in FIG. 1H, and by reference number 170, the video system 110 may provide the new BEV prediction to the vehicle. For example, the video system 110 may provide the new BEV prediction to the vehicle, and the vehicle may receive and display (e.g., to a driver) the new BEV prediction. The driver may utilize the new BEV prediction to navigate the vehicle (e.g., through narrow streets, for parking purposes, and/or the like). In some implementations, the video system 110 may implement the trained BEV system in the camera 105 and/or in the vehicle. In such implementations, the camera 105 and/or the vehicle may process the additional video data, with the trained BEV model, in order to generate the new BEV prediction, without utilizing the video system 110.

In this way, the video system 110 provides self-supervised training of a BEV semantic mapping model. For example, the video system 110 may utilize a self-supervised training method that derives accurate BEV semantic segmentation predictions from video data without the need for expensive sensors or ground truth labels. By processing video frames with a BEV model and a geometry model, the video system 110 may compute a rendered semantic segmentation that is compared against a generated target segmentation. This comparison yields a learnable loss metric that continuously refines model accuracy. The video system 110 may incorporate a pretrained neural field and volumetric rendering techniques to enhance the capture and projection of three-dimensional environmental features into a two-dimensional image, which provides for accurate BEV semantic segmentation predictions. Thus, the video system 110 may conserve computing resources, networking resources, and/or other resources that would have otherwise been consumed by requiring extensive ground truth labels and datasets for training data of the BEV models, utilizing expensive sensors to verify outputs of the BEV models, utilizing extensive post-processing of the outputs generated while training BEV models, and/or the like.

The following is an example implementation of the video system 110. For example, the video system 110 may have access to a sequence of N={1, 2, . . . , n} monocular frontal view video frames I^{k}, k∈N, with corresponding semantic segmentations S^{k} and camera poses with respect to an arbitrary world reference frame M^{k→w}. Given a random frame in the sequence, I^{r}, the video system 110 may execute the BEV model to generate class probabilities for each class (e.g., an output of the final softmax layer, in each pixel of the BEV model, \hat{B}^{r}). To supervise the BEV model, the video system 110 may consider another frame I^{k} and may reconstruct P={1, 2, . . . , p} patches from the semantic segmentation frame S^{k} by performing volumetric rendering of class probabilities. To this end, the video system 110 may emit rays from every pixel in the patch and may sample m points xᵢ, i=1, . . . , m along the ray (uniformly in disparity with an added random noise factor) to discretize the integral of volumetric rendering. Volumetric rendering may need a density value at each three-dimensional (3D) point in space. The video system 110 may obtain the density value by querying a neural field, pretrained in a self-supervised way.

Hence, for each point xᵢ in a ray going through pixel (u, v), the video system 110 may query the volumetric density value σₓᵢ from a frozen model ω. The video system 110 may compute features in ω from the frame from which the ray is cast. In particular, let δᵢ be the distance between xᵢ and xᵢ+1, and αᵢ be the probability of a ray hitting a surface in a 3D position between xᵢ and xᵢ+1, then:

$${α}_{i} = exp ( 1 - {σ}_{x i} {δ}_{i} ) . \qquad ( 1 )$$

Given the previous αⱼ, j=1, . . . , i−1, along a ray, the video system 110 may compute the probability Tᵢ that the ray travels in free space before xᵢ as:

$${T}_{i} = {\prod }_{j = 1}^{i - 1} ( 1 - {α}_{j} ) . \qquad ( 2 )$$

This is routinely used in novel view synthesis to decide a color ê of a pixel by integrating colors of the 3D points cₓᵢ along the ray as:

$$\hat{c} = {\sum }_{i = 1}^{m} {T}_{i} {α}_{i} {c}_{x i} . \qquad ( 3 )$$

Since the aim is to render class probability, the video system 110 may associate a vector of class probabilities to each point in 3D space. These values may come from the predicted BEV for I^{r} so that it can be supervised by the rendering. Thus, the video system 110 may sample class probability distribution values from the network-generated BEV semantic segmentation \hat{B}^{r} of the reference image I^{r}. The video system 110 may transform the 3D points xᵢ to its 3D frame using camera poses M^{k→r}=(M^{r→w})⁻¹M^{k→w} and may orthographically project the transformed points xᵢ to the BEV (i.e., dropping the vertical coordinate y), with the projection (in homogeneous coordinates):

$$π ⊥ = [ \begin{matrix}1 & 0 & 0 & 0 \\ 0 & 0 & 1 & 0 \\ 0 & 0 & 0 & 1\end{matrix} ] . \qquad ( 4 )$$

Therefore, a class probability

$${l}_{{x}_{i}}^{k}$$

is obtained for each point xᵢ along a ray cast from frame k, by the operation described in Equation (5):

$${l}_{{x}_{i}}^{k} = {\hat{B}}^{r} ( π ⊥ 〈 ( {M}^{k \to r} {x}_{i} ) 〉 , \qquad ( 5 )$$

where [symbol] · [symbol] is the nearest neighbor sampling operator. This scheme relies on the assumption that the class is constant across the pillar stemming from each position in the BEV. There are cases where this assumption doesn't hold (e.g., when part of an object “floats” above another, like a building's balcony above a sidewalk or a tree canopy extending above a road). However, it is an acceptable approximation. The video system 110 may apply the softmax prior to rendering and not afterwards. Otherwise, the unbounded nature of the results produced by the BEV model could lead to violations of the geometric constraints imposed by the neural density field.

Finally, the video system 110 may obtain the class probability prediction for the pixels u, v in a patch in the target frame k using the rendering equation with the previously computed probabilities for each 3D point along the ray:

$${\hat{l}}_{u , v}^{k} = {\sum }_{i = 1}^{m} {T}_{i} {α}_{i} {l}_{{x}_{i}}^{k} . \qquad ( 6 )$$

The loss function is then a class-weighted cross-entropy between the prediction and the semantic segmentation label in S^{k} at pixel (u, v) aggregated across the sampled patches:

$${ℒ}_{u , v}^{k} = W C E ( {\hat{l}}_{u , v}^{k} , {S}_{u , v}^{k} ) . \qquad ( 7 )$$

The total loss for a frame is the average of the losses for all pixels of all patches. Points along the rays might fall outside of the area where the BEV semantic segmentation of the reference image \hat{B}^{r} is defined, thus not having valid values to sample. Including rays with many of these points in the supervision could negatively affect the training, thus the video system 110 may perform a volumetric rendering of an indicator variable for the 3D point falling outside the reference BEV \hat{B}^{r} and may filter out rays for which the rendered value exceeds a certain threshold t.

Given a sequence, the video system 110 may analyze multiple frames to supervise the BEV model at a reference I^{r} and may average the loss across them. It is common practice (e.g., in the self-supervised depth-from-mono) to utilize adjacent frames in a video sequence, (e.g., let k be either r−1 or r+1) to compute self-supervised losses. However, letting k vary only in this close range may be detrimental.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

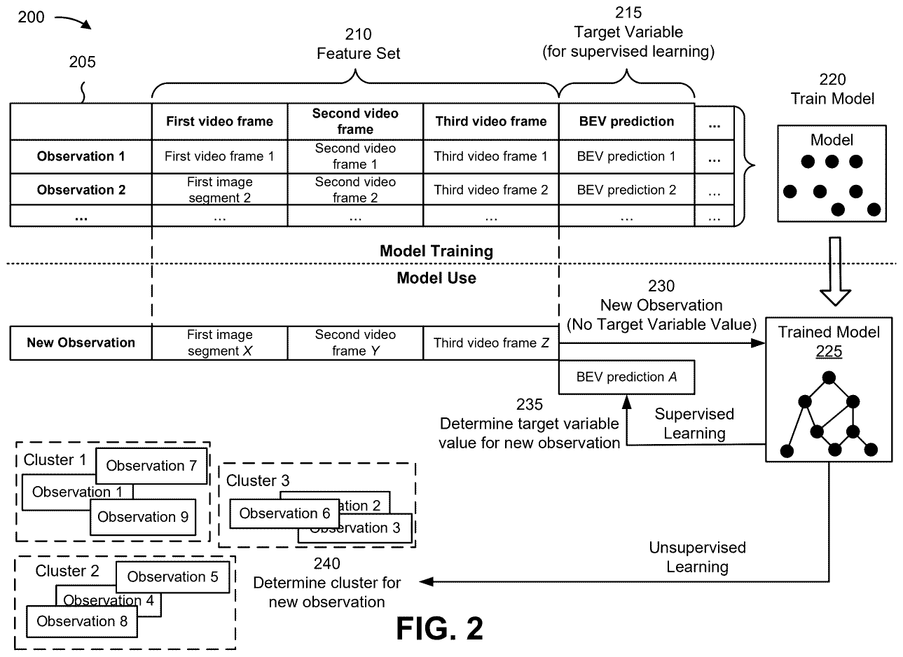

FIG. 2 is a diagram illustrating an example 200 of training and using a machine learning model for generating a BEV semantic map for a vehicle. The machine learning model training and usage described herein may be performed using a machine learning system. The machine learning system may include or may be included in a computing device, a server, a cloud computing environment, and/or the like, such as the video system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the video system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the video system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of a first image segment, a second feature of a second image segment, a third feature of a third image segment, and so on. As shown, for a first observation, the first feature may have a value of a first image segment 1, the second feature may have a value of a second image segment 1, the third feature may have a value of a third image segment 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “stability” and may include a value of stability 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of a first image segment X, a second feature of a second image segment Y, a third feature of a third image segment Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of stability A for the target variable of the stability for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first image segment cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second image segment cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate a BEV semantic map for a vehicle. The machine learning system enables recognition and/or identification of tens, hundreds, thousands, or millions of features and/or feature values for tens, hundreds, thousands, or millions of observations, thereby increasing accuracy and consistency and reducing delay associated with generating a BEV semantic map for a vehicle relative to requiring computing resources to be allocated for tens, hundreds, or thousands of operators to manually generate a BEV semantic map for a vehicle.

As indicated above, FIG. 2 is provided as an example. Other examples may differ from what is described in connection with FIG. 2.

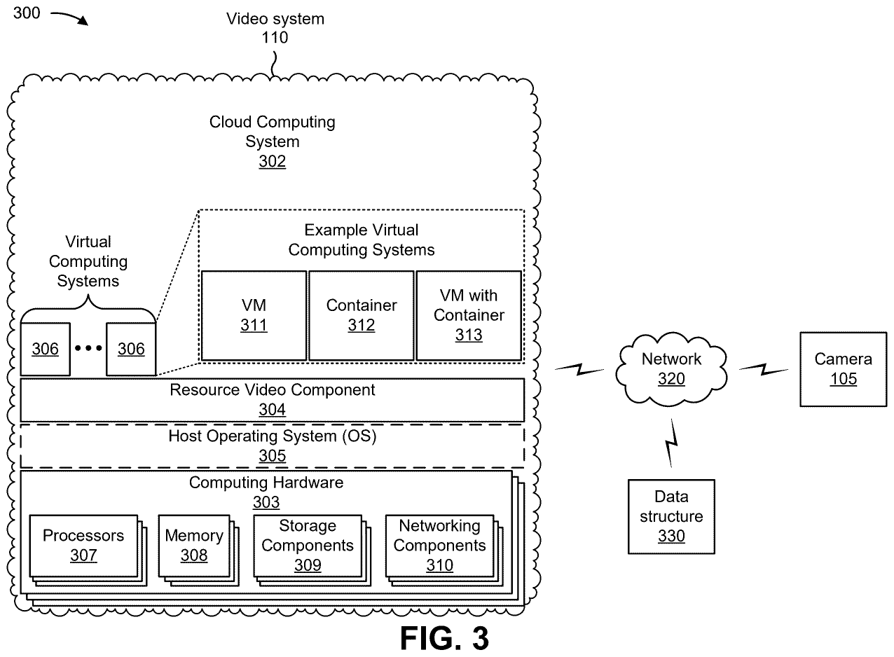

FIG. 3 is a diagram of an example environment 300 in which systems and/or methods described herein may be implemented. As shown in FIG. 3, the environment 300 may include the video system 110, which may include one or more elements of and/or may execute within a cloud computing system 302. The cloud computing system 302 may include one or more elements 303-313, as described in more detail below. As further shown in FIG. 3, the environment 300 may include the camera 105, a network 320, and/or a data structure 330. Devices and/or elements of the environment 300 may interconnect via wired connections and/or wireless connections.

The camera 105 may include one or more devices capable of receiving, generating, storing, processing, providing, and/or routing information, as described elsewhere herein. The camera 105 may include a communication device and/or a computing device. For example, the camera 105 may include an optical instrument that captures videos (e.g., images and audio). The camera 105 may feed real-time video directly to a screen or a computing device for immediate observation, may record the captured video (e.g., images and audio) to a storage device for archiving or further processing, and/or the like. In some implementations, the camera 105 may include a dashcam of a vehicle, a forward-facing camera of a vehicle, a side camera of a vehicle, a rear camera of a vehicle, and/or the like.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

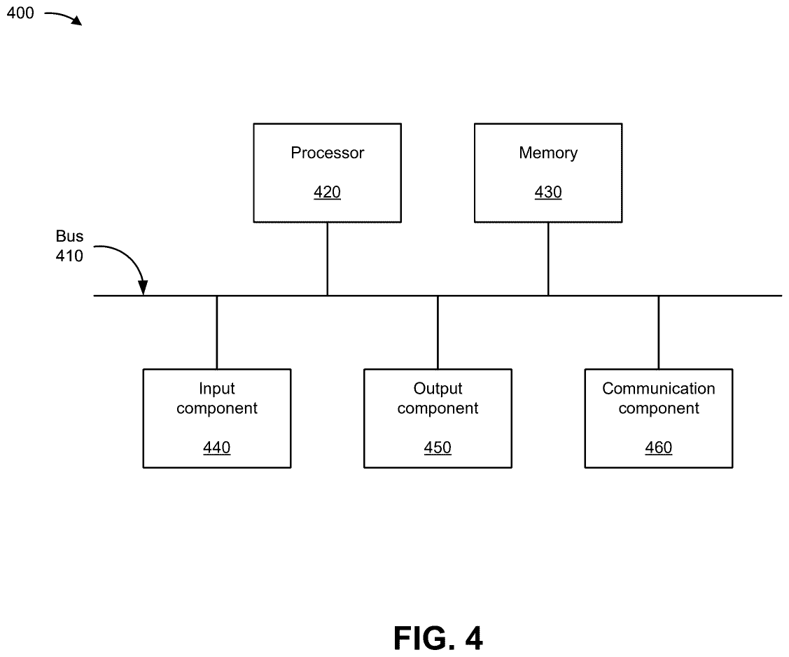

Although the video system 110 may include one or more elements 303-313 of the cloud computing system 302, may execute within the cloud computing system 302, and/or may be hosted within the cloud computing system 302, in some implementations, the video system 110 may not be cloud-based (e.g., may be implemented outside of a cloud computing system) or may be partially cloud-based. For example, the video system 110 may include one or more devices that are not part of the cloud computing system 302, such as a device 400 of FIG. 4, which may include a standalone server or another type of computing device. The video system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the camera 105, the video system 110, and/or the data structure 330. In some implementations, the camera 105, the video system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

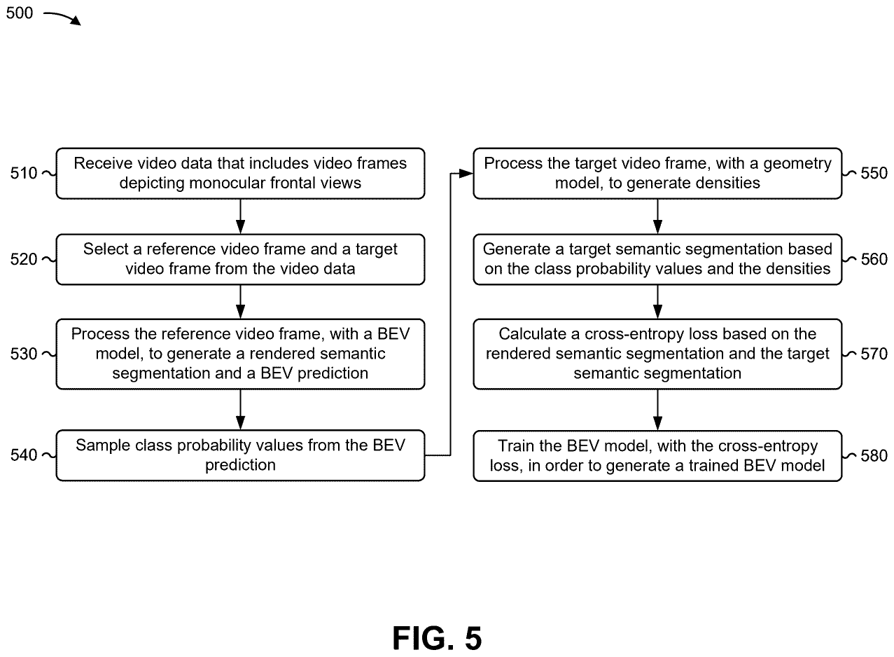

FIG. 5 depicts a flowchart of an example process 500 for self-supervised training of a BEV semantic mapping model. In some implementations, one or more process blocks of FIG. 5 may be performed by a device (e.g., the video system 110). In some implementations, one or more process blocks of FIG. 5 may be performed by another device or a group of devices separate from or including the device, such as a control system of the vehicle, a camera (e.g., the camera 105), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving video data that includes video frames depicting monocular frontal views (block 510). For example, the device may receive video data that includes video frames depicting monocular frontal views, as described above.

As further shown in FIG. 5, process 500 may include selecting a reference video frame and a target video frame from the video data (block 520). For example, the device may select a reference video frame and a target video frame from the video data, as described above.

As further shown in FIG. 5, process 500 may include processing the reference video frame, with a BEV model, to generate a rendered semantic segmentation and a BEV prediction (block 530). For example, the device may process the reference video frame, with a BEV model, to generate a rendered semantic segmentation and a BEV prediction, as described above. In some implementations, the BEV model is a BEV semantic segmentation network model.

As further shown in FIG. 5, process 500 may include sampling class probability values from the BEV prediction (block 540). For example, the device may sample class probability values from the BEV prediction, as described above. In some implementations, sampling the class probability values from the BEV prediction includes collecting the class probability values associated with each pixel or segment within the BEV prediction to generate a probabilistic map.

As further shown in FIG. 5, process 500 may include processing the target video frame, with a geometry model, to generate densities (block 550). For example, the device may process the target video frame, with a geometry model, to generate densities, as described above. In some implementations, the geometry model is a pretrained neural field. In some implementations, processing the target video frame, with the geometry model, to generate the densities includes utilizing a point cloud processor to analyze the target video frame and convert image pixels into a three-dimensional point cloud representation to extract the densities from the target video frame.

As further shown in FIG. 5, process 500 may include generating a target semantic segmentation based on the class probability values and the densities (block 560). For example, the device may generate a target semantic segmentation based on the class probability values and the densities, as described above. In some implementations, generating the target semantic segmentation based on the class probability values and the densities includes performing a volumetric rendering of a semantic perspective view for the target video frame using the class probability values and the densities, wherein the semantic perspective view corresponds to the target semantic segmentation.

As further shown in FIG. 5, process 500 may include calculating a cross-entropy loss based on the rendered semantic segmentation and the target semantic segmentation (block 570). For example, the device may calculate a cross-entropy loss based on the rendered semantic segmentation and the target semantic segmentation, as described above. In some implementations, calculating the cross-entropy loss based on the rendered semantic segmentation and the target semantic segmentation includes calculating a class-weighted cross-entropy loss between the rendered semantic segmentation and the target semantic segmentation.

As further shown in FIG. 5, process 500 may include training the BEV model, with the cross-entropy loss, in order to generate a trained BEV model (block 580). For example, the device may train the BEV model, with the cross-entropy loss, in order to generate a trained BEV model, as described above. In some implementations, training the BEV model, with the cross-entropy loss, in order to generate the trained BEV model includes back-propagating the cross-entropy loss through the BEV model to generate the trained BEV model. In some implementations, training the BEV model, with the cross-entropy loss, in order to generate the trained BEV includes averaging the cross-entropy loss across multiple video frames to update parameters of the BEV model and to generate the trained BEV model. In some implementations, training the BEV model, with the cross-entropy loss, in order to generate the trained BEV model includes adjusting parameters of the BEV model based on the cross-entropy loss and to generate the trained BEV model.

In some implementations, process 500 includes receiving additional video data that includes video frames depicting monocular frontal views, processing the additional video data, with the trained BEV model, to generate a new BEV prediction, and providing the new BEV prediction. In some implementations, process 500 includes implementing the trained BEV model in a vehicle. In some implementations, process 500 includes implementing the trained BEV model in a camera that captured the video data.

In some implementations, process 500 includes generating semantic segmentation labels based on the rendered semantic segmentation and the target semantic segmentation, and training the BEV model, with the semantic segmentation labels, to generate the trained BEV model. In some implementations, process 500 includes receiving camera calibration and pose information associated with the video data, and utilizing the camera calibration and pose information with the geometry model to generate the densities.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, video data that includes video frames depicting monocular frontal views;
selecting, by the device, a reference video frame and a target video frame from the video data;
processing, by the device, the reference video frame, with a bird's eye view (BEV) model, to generate a rendered semantic segmentation and a BEV prediction;
sampling, by the device, class probability values from the BEV prediction;
processing, by the device, the target video frame, with a geometry model, to generate densities;
generating, by the device, a target semantic segmentation based on the class probability values and the densities;
calculating, by the device, a cross-entropy loss based on the rendered semantic segmentation and the target semantic segmentation; and
training, by the device, the BEV model, with the cross-entropy loss, in order to generate a trained BEV model.

2. The method of claim 1, further comprising:
receiving additional video data that includes video frames depicting monocular frontal views;
processing the additional video data, with the trained BEV model, to generate a new BEV prediction; and
providing the new BEV prediction.

3. The method of claim 1, wherein sampling the class probability values from the BEV prediction comprises:
collecting the class probability values associated with each pixel or segment within the BEV prediction to generate a probabilistic map.

4. The method of claim 1, wherein processing the target video frame, with the geometry model, to generate the densities comprises:
utilizing a point cloud processor to analyze the target video frame and convert image pixels into a three-dimensional point cloud representation to extract the densities from the target video frame.

5. The method of claim 1, wherein generating the target semantic segmentation based on the class probability values and the densities comprises:
performing a volumetric rendering of a semantic perspective view for the target video frame using the class probability values and the densities,
wherein the semantic perspective view corresponds to the target semantic segmentation.

6. The method of claim 1, further comprising:
generating semantic segmentation labels based on the rendered semantic segmentation and the target semantic segmentation; and
training the BEV model, with the semantic segmentation labels, to generate the trained BEV model.

7. The method of claim 1, further comprising:
receiving camera calibration and pose information associated with the video data; and
utilizing the camera calibration and pose information with the geometry model to generate the densities.

8. A device, comprising:
one or more processors configured to:
receive video data that includes video frames depicting monocular frontal views;
select a reference video frame and a target video frame from the video data;
process the reference video frame, with a bird's eye view (BEV) model, to generate a rendered semantic segmentation and a BEV prediction;
sample class probability values from the BEV prediction;
process the target video frame, with a geometry model, to generate densities;
generate a target semantic segmentation based on the class probability values and the densities;
calculate a cross-entropy loss based on the rendered semantic segmentation and the target semantic segmentation;
train the BEV model, with the cross-entropy loss, in order to generate a trained BEV model;
receive additional video data that includes video frames depicting monocular frontal views;
process the additional video data, with the trained BEV model, to generate a new BEV prediction; and
provide the new BEV prediction.

9. The device of claim 8, wherein the geometry model is a pretrained neural field.

10. The device of claim 8, wherein the one or more processors, to calculate the cross-entropy loss based on the rendered semantic segmentation and the target semantic segmentation, are configured to:
calculate a class-weighted cross-entropy loss between the rendered semantic segmentation and the target semantic segmentation.

11. The device of claim 8, wherein the one or more processors, to train the BEV model, with the cross-entropy loss, in order to generate the trained BEV model, are configured to:
backpropagate the cross-entropy loss through the BEV model to generate the trained BEV model.

12. The device of claim 8, wherein the one or more processors, to train the BEV model, with the cross-entropy loss, in order to generate the trained BEV, are configured to:
average the cross-entropy loss across multiple video frames to update parameters of the BEV model and to generate the trained BEV model.

13. The device of claim 8, wherein the one or more processors, to train the BEV model, with the cross-entropy loss, in order to generate the trained BEV model, are configured to:
adjust parameters of the BEV model based on the cross-entropy loss and to generate the trained BEV model.

14. The device of claim 8, wherein the BEV model is a BEV semantic segmentation network model.

15. A non-transitory computer-readable medium storing a set of instructions, the set of instructions comprising:
one or more instructions that, when executed by one or more processors of a device, cause the device to:
receive video data that includes video frames depicting monocular frontal views;
select a reference video frame and a target video frame from the video data;
process the reference video frame, with a bird's eye view (BEV) model, to generate a rendered semantic segmentation and a BEV prediction,
wherein the BEV model is a BEV semantic segmentation network model;
sample class probability values from the BEV prediction;
process the target video frame, with a geometry model, to generate densities;
generate a target semantic segmentation based on the class probability values and the densities;
calculate a cross-entropy loss based on the rendered semantic segmentation and the target semantic segmentation; and
train the BEV model, with the cross-entropy loss, in order to generate a trained BEV model.

16. The non-transitory computer-readable medium of claim 15, wherein the one or more instructions further cause the device to:
implement the trained BEV model in a camera that captured the video data.

17. The non-transitory computer-readable medium of claim 15, wherein the one or more instructions, that cause the device to generate the target semantic segmentation based on the class probability values and the densities, cause the device to:
perform a volumetric rendering of a semantic perspective view for the target video frame using the class probability values and the densities,
wherein the semantic perspective view corresponds to the target semantic segmentation.

18. The non-transitory computer-readable medium of claim 15, wherein the one or more instructions further cause the device to:
generate semantic segmentation labels based on the rendered semantic segmentation and the target semantic segmentation; and
train the BEV model, with the semantic segmentation labels, to generate the trained BEV model.

19. The non-transitory computer-readable medium of claim 15, wherein the one or more instructions further cause the device to:
receive camera calibration and pose information associated with the video data; and
utilize the camera calibration and pose information with the geometry model to generate the densities.

20. The non-transitory computer-readable medium of claim 15, wherein the one or more instructions, that cause the device to calculate the cross-entropy loss based on the rendered semantic segmentation and the target semantic segmentation, cause the device to:
calculate a class-weighted cross-entropy loss between the rendered semantic segmentation and the target semantic segmentation.
